(19) United States
(12) Patent Application Publication
(10) Pub. No.: US 2002/0032649 A1
(43) Pub. Date: Mar. 14, 2002

(54) High-security E-currency IDs for E-commerce transactions

(76) Inventor: Balamurugan Selvarajan, Richmond, CA (US)

Correspondence Address: John P. Wooldridge, 1334 Ridgestone Court, Livermore, CA, 94550, US

(21) Appl. No.: 09/833,468

(22) Filed: Apr. 11, 2001

Related U.S. Application Data
(60) Provisional application No. 60/196,786, filed on Apr. 13, 2000.

(51) Int. Cl. G06F 17/60

(52) U.S. Cl. 705/40; 705/39; 705/26

(57) ABSTRACT

E-currency ID provides a highly secure, single-usage ‘virtual card’ that can be used for purchase on the Internet, while maintaining user privacy, security and control. Anytime the user needs to use a credit card on the Internet, they can use a unique e-currency ID instead. No actual card information is transmitted to the vendor and the e-currency ID cannot be reused, thus providing security against misuse of information even if the vendor's security system is breached. The user can optionally setup for notification and confirmation, wherein all request from vendors for payment authorization are sent to the user (notification) and are only authorized after user approval (confirmation). The invention also provides capability for setting up recurring payments using e-currency Ids.

This application claims priority to Provisional Patent Application Serial No. 60/196,786, titled “High-Security E-Currency Ids For E-Commerce Transactions,” filed Apr. 13, 2000, incorporated herein by reference.

### BACKGROUND OF THE INVENTION

1. Field of the Invention

The present invention relates to e-commerce, and more specifically, it relates to methodologies for securing e-commerce transactions, while providing user control.

2. Description of Related Art

The concept of e-currency IDs (also referred to in this invention as Internet IDs) was developed to greatly increase security of e-commerce transactions while reducing (and in some cases removing) the need for changes to existing payment systems and to provide customers with as much control with their Credit/Debit cards as they get with, say a check. For the most part, when a user provides card information over the Internet, they have no way of knowing the exact amount charged till they see their statement and have no control over the charging process. Additionally, when the security of the e-commerce vendor to which they provided the card information is compromised, the user is not protected against misuse of the information.

Several initiatives (notably SET from MasterCard) have been made to address the security issue, but none are meant to provide control to the user. All the initiatives require changes to existing system and require additional digital certificates (from users as well as vendors) to protect the data. In contrast, e-currency Ids provide a very high level of security by simply avoiding transmission/reuse of the card information and provides control to the customer as to when, how and how much is charged to the card.

Unlike the prior-art e-Wallet, which is like a real life wallet containing a collection of credit and debit cards (that do not require a PIN), e-currency ID is a ‘virtual card’. Using an e-wallet, the user selects one of the cards from the wallet and uses it when making a purchase. e-Wallet just provides convenience to the user (they don't have to re-enter their card information for each vendor). It does not address the security issues (it merely sends the card information on behalf of the user) and does not address the end-to-end control over the transaction like e-currency Ids.

The key difference between e-currency ID and e-Wallet is that, no card information is transmitted with e-currency Ids and the users have absolute control over their cards. e-Wallet is a collection of existing cards, while Internet ID is a ‘virtual’ card. In fact, e-currency ID can be used as a valid card in a typical e-Wallet system.

Another distinction is that, e-Wallet's may require an e-Commerce site to make specific changes to accommodate it While with e-currency ID if directly provided by a leading card provider like Visa or Mastercard, does not require any change to the participating e-Commerce site.

The e-currency ID has several advantages, the foremost of them being security. Many small business e-Commerce sites do not have the security infrastructure and are easy targets for crackers to steal credit card information. With the e-currency ID the card/account information is only stored at the Service Provider. Only the Ids are sent to the e-Commerce sites. If these sites are compromised, the stolen Ids cannot be reused for purchase.

Another major advantage is control and feedback for the users. wherein the user knows exactly how much is being charged and by whom The user also has the option of declining the transaction anytime before confirmation. Further, recurring payee/payment requests can be selectively disabled by the user by modifying the user configuration.

U.S. Pat. No. 6,016,484, titled “System, Method And Article Of Manufacture For Network Electronic Payment Instrument And Certification Of Payment And Credit Collection Utilizing A Payment” is similar to e-Wallet, but with client side certificates for added security. This invention does not address breach of security on e-commerce site, or user control.

U.S. Pat. No. 5,987,140, titled “System, Method And Article Of Manufacture For Secure Network Electronic Payment And Credit Collection” addresses security during transmission, but does not address breach of security on e-commerce site, or user control.

U.S. Pat. No. 5,963,924, titled “System, Method And Article Of Manufacture For The Use Of Payment Instrument Holders And Payment Instruments In Network Electronic Commerce” is similar to U.S. Pat. No. 6,016,484 above, but additionally asks for user confirmation before sending the card information. An important point to note is that, the prior art transmits the actual card information and does not provide for user confirmation (or rejection) when the merchant sends a request for authorization. Essentially, it does not address end-to-end user control or reuse of card information by unauthorized personnel.

### SUMMARY OF THE INVENTION

The present invention provides an E-currency ID that is a highly secure, single-usage ‘virtual card’ that can be used to make purchases on the Internet, while maintaining user privacy, security and control. Users would register with the ‘Virtual Card Service Provider’ or VCSP, (also referred to as Service Provider in this invention), provide their account or credit card information and download a VCSP client (also referred to as Client in this invention). Anytime they need to use a credit card on the Internet, they can use a unique ID generated by the VCSP client The ‘virtual card’ in itself does not provide a line of credit; it just uses the existing credit or debit accounts to provide a secure and private transaction on the Internet FIG. 1 shows client browser 1 and VCSP client 2 on a user's PC 5. Client browser 1 can be communicatively coupled to an e-commerce site 3 and VCSP 4. The e-commerce site can be communicatively coupled to the VCSP 4. (The same concept can be used for existing credit cards without any change to provide the user with feedback and control. However, using the existing credit card will not provide the same level of security that an e-currency ID provides.)

In one embodiment, the system includes a VCSP client 2 (that users would download from the VCSP 4), the VCSP server, and authentication mechanism, secure data transfer (for example Secure Socket Layer or SSL) and feedback mechanism. The system can also include an optional card reader for added security.

Users register with the VCSP 4 by providing their bank account or credit account information and download the VCSP client 2 (see FIG. 2). Any time the user needs to use a credit card, they operate the client (which can be automatic or with user intervention) to generate a unique ID (see FIG. 1). The site receiving the number validates it with the VCSP 4. The receiving site does not receive the actual credit card number. The generated ID is unique for each session and cannot be reused. This way, if the receiving site's security was compromised, the generated IDs cannot be used to make purchases.

The VCSP client provides the mechanism for user interaction with the VCSP for generating and using of the secure IDs. In one embodiment of this invention, the VCSP client is on a small window on the users' desktop. The users operate their browsers to go on the Internet or to make purchases, as they would normally. When they need to provide credit card information, they operate the VCSP client, which connects to the VCSP server and receives a unique ID. The user then enters (either through “drag & drop” or “cut & paste” or manual entry) this ID on the e-Commerce site to make the purchase. FIG. 3 illustrates the purchasing configuration.

The VCSP server generates the unique ID each time a VCSP client requests one. Each VCSP client can be identified individually (either using username/password or automatic addition of unique identifier into the VCSP client following registration). The IDs are unique and have a preset timeout (for example 30 minutes). The IDs can be encrypted before transmission. After the timeout expires, this ID will not be approved by the VCSP.

In one embodiment, the client has four modes: “notification”, “confirmation”, “card reader” and “recurring payment”. In notification mode, anytime an e-commerce site requests validation of an e-Currency, the service notifies the user. With the “confirmation” setting, anytime an e-Commerce site requests validation of an ID generated by this user, a confirmation is requested from the user. Only after the user authorizes the transaction does the VCSP approve it.

In “card reader” setting, the VCSP client works only after the user inserts a service card into a special reader attached to the PC. This prevents unauthorized use of the VCSP client and additionally removes the need for user IDs and passwords. This also provides the user with a psychological comfort zone in using the Internet.

“Recurring payment” provides the capability to setup recurring bills. In recurring payment mode, all information to complete the recurring transaction (including the merchant account, payment frequency, time period for recurrence etc.,) is stored at the Service Provider. The request from an e-commerce site with the same e-currency ID just acts as a ‘trigger’ for that recurring transaction, which is completed by the service provider based on the information stored during the original transaction. The old e-currency ID (which technically expired after the original transaction) can only be used as a ‘trigger’ and cannot be used for any actual payment transactions. This way security can be maintained even if the e-commerce site was compromised. The service provider may also do a ‘reverse lookup’ to validate that the requesting e-commerce site is really the one for which the user authorized the transaction and whether the user has disabled recurring payment for this site or the time period for the recurring transaction has expired.

The user has the option of changing any of these settings at anytime. The settings can also be modified based on payment requestor (selectively enabling or disabling payments to specific e-commerce sites). The user may also setup a time period for recurrence on a per-requestor basis, e.g., monthly payments from site A between July and December 1999. Notifications can be sent to the user as email or using chat client, instant messenger, and so forth. The VCSP client can also be used for notification.

The VCSP client may also have the capability to record payment details into personal finance tools like Quicken, MS Money or web based financial application service providers.

The VCSP client can be a separate application interacting with the browser or can be code running on the browser itself (for example an Applet, Plugin, Script etc.,). For users on the move, who do not have access to their personal VCSP client, an applet client can be used. In this case, users would use a user ID and password and login on the VCSP server using a regular browser. An applet can then be started as a temporary VCSP client When the user logs out, the applet is disabled and cannot be used further. The applet will also be automatically disabled if it remains inactive for a period of time (for example 15 minutes).

The VCSP client can also be entirely web based, thereby allowing a high level of user accessibility. In this embodiment, a user logs on to the VCSP server using a user ID and password and accesses the e-Commerce site through the VCSP server. The server parses the actual content from the e-Commerce site and adds scripts/applets (FIG. 6) to the document's content or modifies the Uniform Resource Locator (URL) so that the submitted form is sent to the VCSP server (see FIG. 5). This way, the user views the document exactly as it would have been if viewed directly from the e-commerce site, except that the added code automatically handles any card information. When the user normally submits the form (without having filled in any card information), the added code automatically inserts the Ids (FIG. 6) or the modified URL causes the VCSP server to automatically insert the Ids and send it to the e-Commerce site (FIG. 5).

FIG. 3 shows an example usage process according to the present invention. The user browses to an e-commerce site 3 and selects the product or service to purchase. The e-commerce site then takes the user to a billing page where credit card information is requested. Now the user operates the VCSP client 2 that connects to the Service Provider 4 and receives a unique ID. This ID is used in place of the card information.

FIG. 4 shows an example transaction according to the present invention, based on the example scenario in FIG. 3. At P1, the e-Commerce site requests validation of the e-currency ID from the Service Provider. At P2, the VCSP sends requested payment information and a requestor ID to the client At P3, The VCSP client displays the amount and the requestor ID and asks for confirmation. At P4, user confirmation is sent to the VCSP. At P5, the VCSP checks if the user has the necessary balance for payment and commit the payment transaction. At P6, acceptance is sent to the e-commerce site. If the user has not setup for “confirmation”, steps P3 and P4 may be skipped.

FIG. 5 shows an example Web based client At 5P1, the user logs in to the VCSP and specifies the URL of site to view. At 5P2, the VCSP server contacts the site and retrieves the document At 5P3, the document is parsed, destination URL changed to the VCSP server and the information is sent to the user's browser. The user submits a request at 5P4, which is sent to the VCSP server. The VCSP server automatically adds e-currency Ids at 5P5 and sends the request to the original server at 5P6. FIG. 6 illustrates another embodiment of the Web based client At 6P1, a user logs in to the VCSP and specifies the URL of the site to view. At 6P2, the VCSP server contacts the site and retrieves the document At 6P3, the document is parsed and code is added to transparently handle card information and sent to user's browser. At 6P4, the user submits a request The added code attaches the card information before sending the request to the e-commerce site.

For added security, a client card reader can be used with the VCSP client. The client card reader is similar to a regular card reader. The VCSP would provide a service card (which could be very similar to a normal credit card) to the user's requesting this optional security feature. This card reader is attached to the user's PC. When the VCSP client is operated, it tries to access the card reader (if present) and sends the card information (if the card is present in the reader). The server would check the user configuration and if set to “card reader”, would generate and send the Unique ID only if valid card information has been sent by the client.

The VCSP card encoding and the client card reader could include encryption technology and keys that are specific and proprietary to that VCSP and cannot be forged.

The VCSP server handles the user authentication and generation of the unique Ids. It also checks the payment details and whether the user has the balance for payment It also sends and receives user approval, if the user has requested for confirmation. The server also creates and transmits the necessary transactions to complete the payment. The server typically includes encryption technology (for example Secure Socket Layer) for the data being transmitted or received.

The server also handles client notifications when recurring payments are requested. The client notification can be done through email, VCSP client, Instant Messenger, Chat client, Palm/Internet phone notification etc.,

All user settings (like “confirmation”, “card reader” etc.,) are stored on the server. This way, even if the VCSP client was tampered (for example an attempt to override “card reader” by cracking the VCSP client), the security could still not be breached.

By using unique Ids instead of actual user/card information, the security issues are now centralized at the VCSP level instead of at each of the e-Commerce sites. The server, typically, would include firewall and other security mechanisms to provide truly secure and private transactions.

The E-currency ids can be ‘transparent’ ids or ‘opaque’ ids. Transparent ids, will be very similar to the credit card numbers and the e-Commerce site does not distinguish them as E-currency ids. The payment gateway that receives the ID would identify it as E-currency ID and do the necessary operation. This requires that the VCSP operate the payment gateway, as would be the case when a leading card provider like Visa or Mastercard uses this system. With Opaque Ids, the e-Commerce site identifies the Ids and contacts the appropriate VCSP.

### BRIEF DESCRIPTION OF THE DRAWINGS

FIG. 1 shows the interaction process of the present invention.

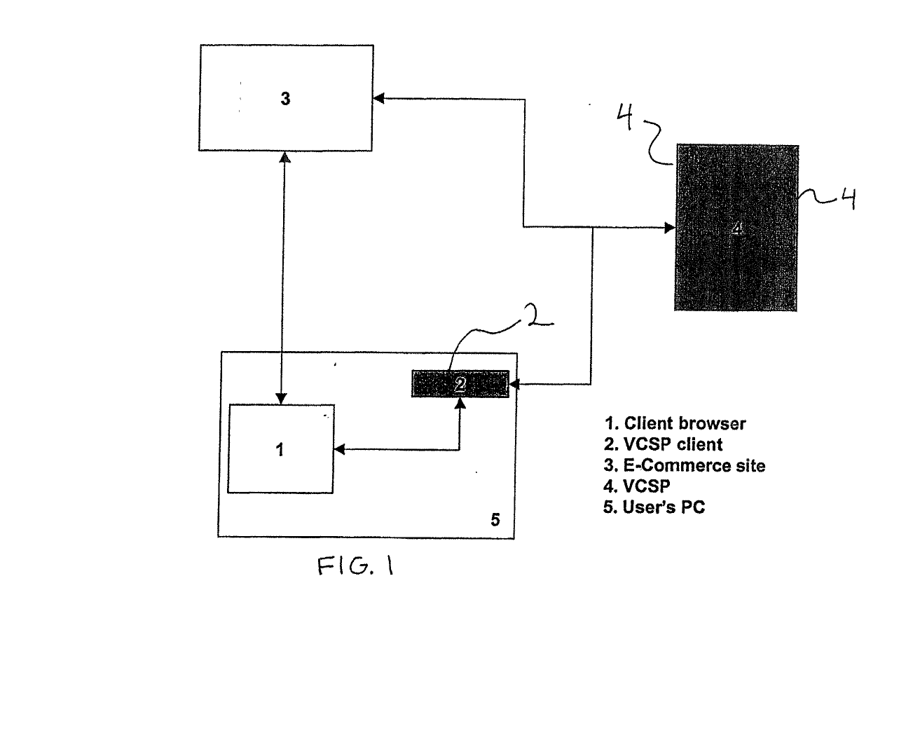

FIG. 2 shows the registration process.

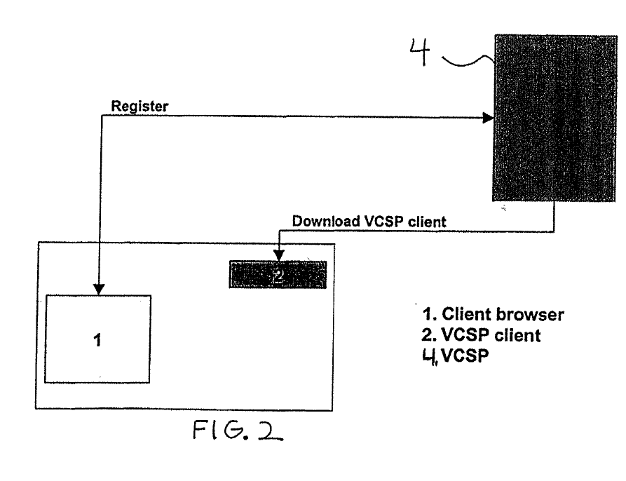

FIG. 3 shows an example purchase according to the present invention.

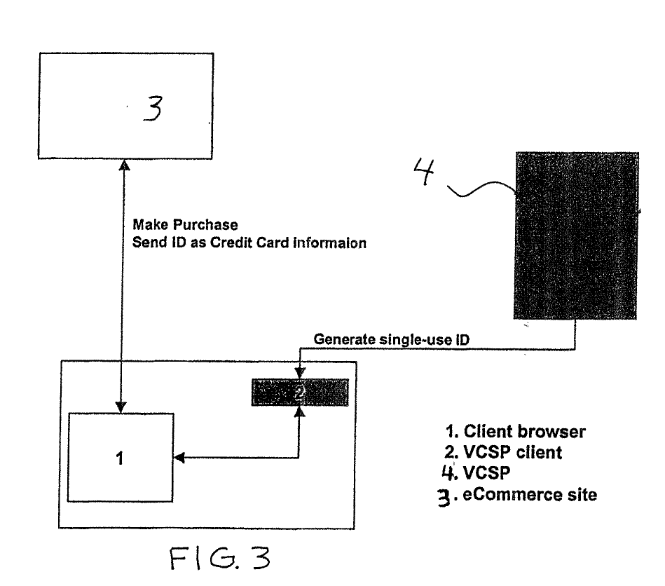

FIG. 4 shows an example transaction according to the present invention.

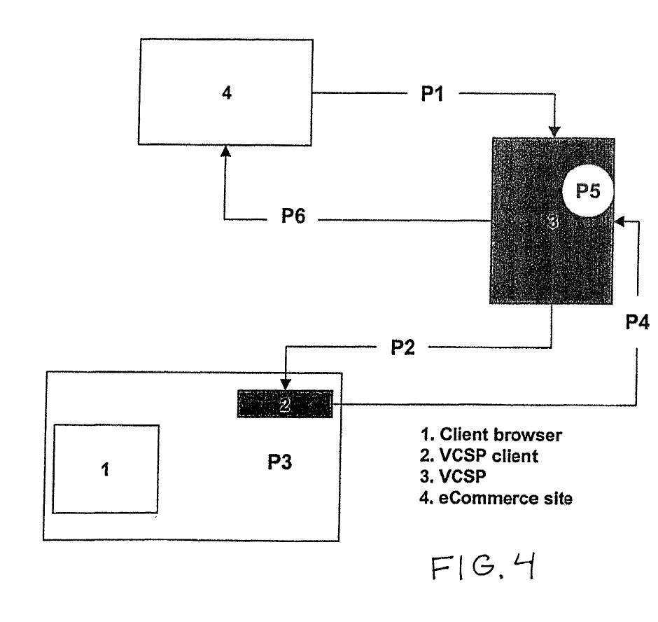

FIG. 5 illustrates one embodiment of the Web based client processes.

FIG. 6 illustrates another embodiment of the Web based client processes.

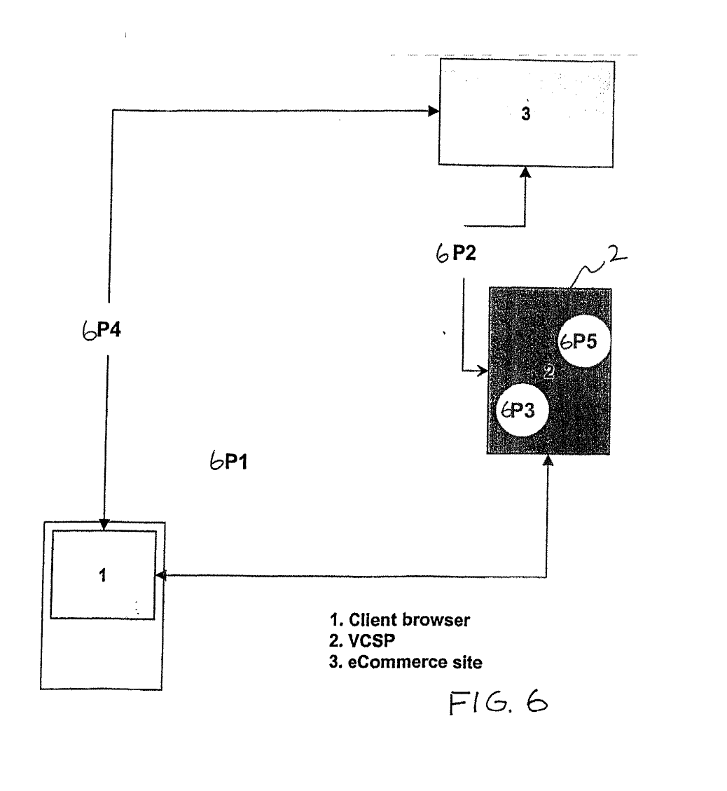

FIG. 7 is a diagram illustrating an e-commerce transaction system 100 incorporating one embodiment of the present invention.

FIG. 8 shows the service provider including one or more of the following: a central processing unit, a memory, a user interface, a port, a communications interface and an internal bus.

FIG. 9 shows the service provider including a registrar, an e-currency-ID generator and an authenticator.

FIG. 10 illustrates the components of the browser.

FIG. 11 shows a conceptual view of the browser application software.

### DETAILED DESCRIPTION OF THE INVENTION

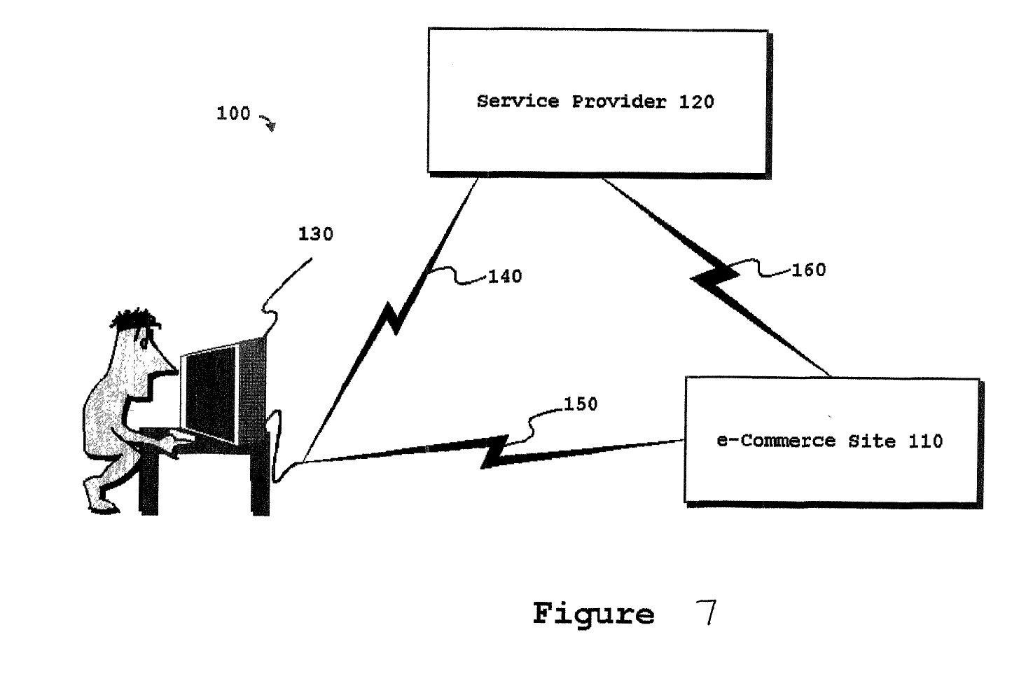

FIG. 7 is a diagram illustrating an e-commerce transaction system 100 incorporating one embodiment of the present invention. The system 100 includes an e-commerce site 110, a service provider 120 and a browser 130. The system 100 also includes the communications links 140,150 and 160.

The link 140 communicatively couples the browser 130 and the service provider 120. The link 150 communicatively couples the browser 130 and the e-commerce site 110, and the link 160 communicatively couples the service provider 120 and the e-commerce site 110. Any two or all of the links 140, 150, 160 may be unity, preferably as the Internet.

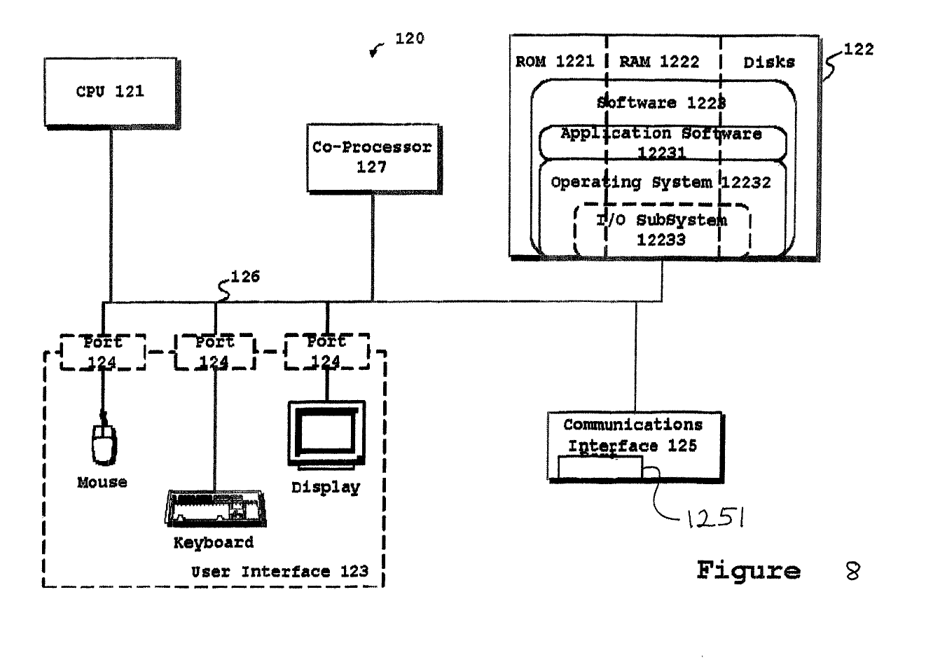

As FIG. 8 illustrates, the service provider 120 includes one or more of the following: a central processing unit (“CPU”) 121, a memory 122, a user interface 123, a port 124, a communications interface 125 and an internal bus 126. (Of course, in an embedded system, some of these components may be missing, as is well understood in the art of embedded systems. In a distributed computing environment, some of these components may be on separate physical machines, as is well understood in the art of distributed computing.)

The memory 122 includes high-speed, volatile random-access memory (RAM) 1222, as well as non-volatile memory such as read-only memory (ROM) 1221 and magnetic disk drives. Further, the memory 122 contains software 1223. The software 1223 is layered: Application software 12231 communicates with the operating system 12232, and the operating system 12232 communicates with the I/O subsystem 12233. The I/O subsystem 12233 communicates with the CPU 121, user interface 123 and the communications interface 125 by means of the communications bus 126.

The memory 122 may be programmed according to the methods described herein.

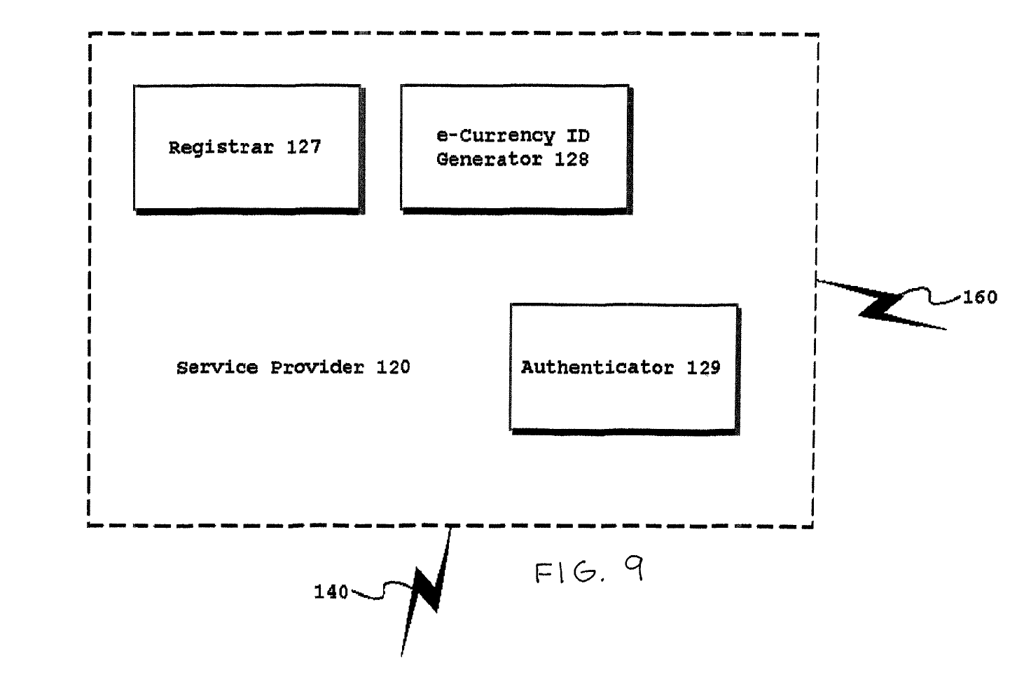

Conceptually, the service provider 120 includes a registrar 127, an e-currency-ID generator 128 and an authenticator 129. See FIG. 9. The registrar 127 registers users of the service 120 and supplies thus registered users with a client 2 (see FIGS. 14). On demand from the client, the e-currency-ID generator 128 generates a unique e-currency ID usable for payment at an e-commerce site 110. In response to a query from the e-commerce site 110, the authenticator 129 authenticates (or rejects) an e-currency ID presented by the e-commerce site 110.

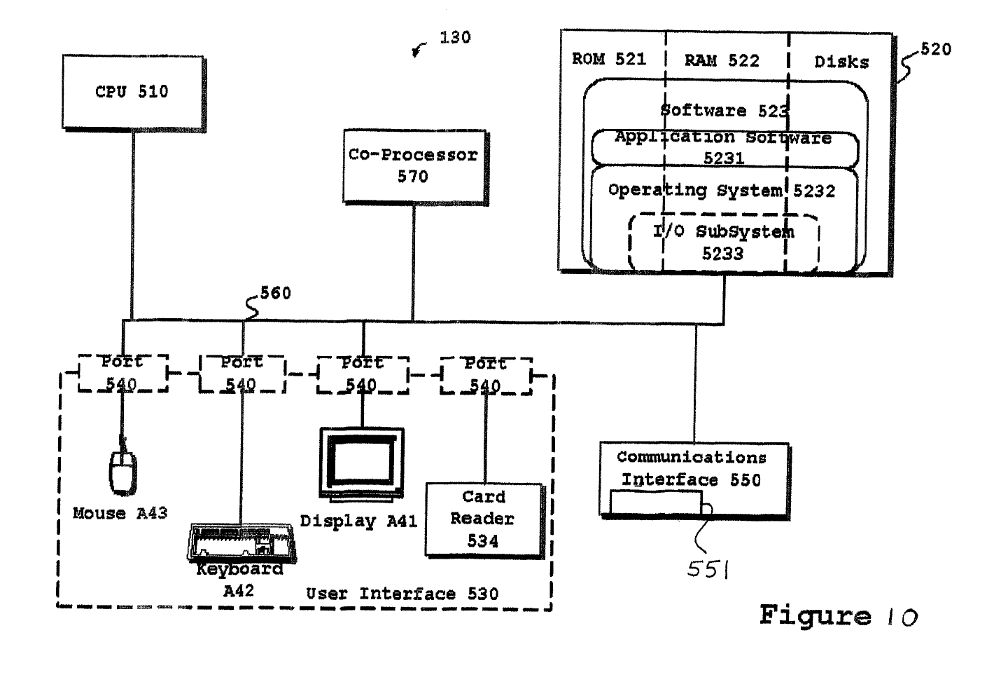

FIG. 10 illustrates the components of the browser 130. The browser 130 includes one or more of the following: a CPU 510, a memory 520, a user interface 530, a port 540, a communications interface 550 and an internal bus 560. The memory 520 may include ROM 521, RAM 522 and magnetic drives. Further, the memory 520 contains software 523. The software 523 is layered: Application software 5231 communicates with the operating system software 5232, and the operating system 5232 communicates with the I/O subsystem 5233. The I/O subsystem 5233 communicates with the CPU 510, the user interface 530 and the communications interface 550 by means of the communications bus 560. The memory 520 may be programmed according to the methods described herein.

The user interface 530 may include a mouse 533, a display 531 and a keyboard 532, as well as a card reader 534. All of these specific interfaces are well known in the art.

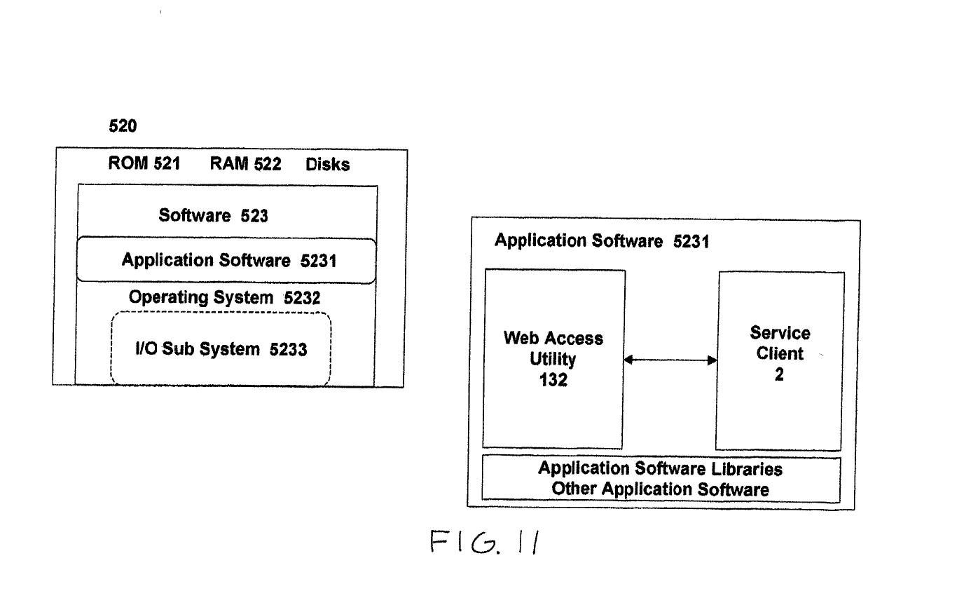

FIG. 11 shows a conceptual view of the browser application software, In the figure, the browser 130 includes the service client 2 and a web-access utility 132. The service client 2 is the means for the consumer to communicate with the service provider 120. The web-access utility 132 is the means for the consumer to register with the service provider (assuming that the links 140,150 are the Internet) and to communicate with an e-commerce site 110. (The client 2 may be a separate application interacting with the web-access utility 132 or may be integrated with the web-access utility 132 within the browser 130 itself.)

### Viewpoint of User

From the user viewpoint, the e-commerce transaction system 100 operates as follows: A user communicates over the link 140 with the service provider 120 and registers with the registrar 127, providing bank account or credit-card information. (The information is sufficient to authorize a transaction.) On successful registration, the user downloads a service client 2.

At some time (before, during or after browsing after downloading the client 2), the user may configure the client 2. In one embodiment, the client 2 has four modes: confirmation, card reader, recurring payment and notification. Each of these modes is in an ON or OFF state.

In notification mode, anytime an e-commerce site 110 requests validation of an e-currency ID for a transaction, the service 120 notifies the user (preferably using a communications medium independent of the service 120 itself) of the existence of the request Notification may be by e-mail, chat, instant messaging, paging, (internet) telephony, hand-held computer wireless service, etc. or through the client 2 itself.

In confirmation mode, for each payment request, the provider 129 in turn notifies the user of the request and, additionally, requests confirmation from the user that he is currently engaged in that transaction. Only after the user confirms to the service provider 129 his participation in the transaction does the authenticator 129 approve the e-currency ID to the e-commerce site 110.

In card-reader mode, the client 2 becomes active only after the user inserts a service card into the card reader 534. This mode helps prevent unauthorized use of the service client 2 and makes the service easier to use by eliminating the need to enter user names and passwords. The mode may also increase the user's psychological comfort in using the Internet

The service card may appear similar to a credit card.

In recurring-payment mode, the user specifies information to complete a recurring transaction. The user specifies, for example, a merchant identifier, a merchant account, a payment frequency, a payment amount and a validity period. (Say, monthly payments to The Big-Screen TV Store, Cooperstown, Ohio, from July 1999 through December 2000.) The user receives an e-currency ID to provide to the merchant for the recurring payments.

The user expects that the service will pay the specified amount on the specified account at the specified merchant at the specified times. Recurring-payment mode enables, for example, the payment of recurring bills.

If both confirmation mode and recurring-payment mode are enabled, the service 120 notifies the user of a recurring request and authorizes the transaction only after the user approves.

The user may configure the client 2 to record payment details into personal-finance tool such as Quicken, MS Money or web-based financial-application service providers.

The user may change any of these settings at any time. The user may set a mode on a per-requestor basis, selectively enabling or disabling payments to specific e-commerce sites 110.

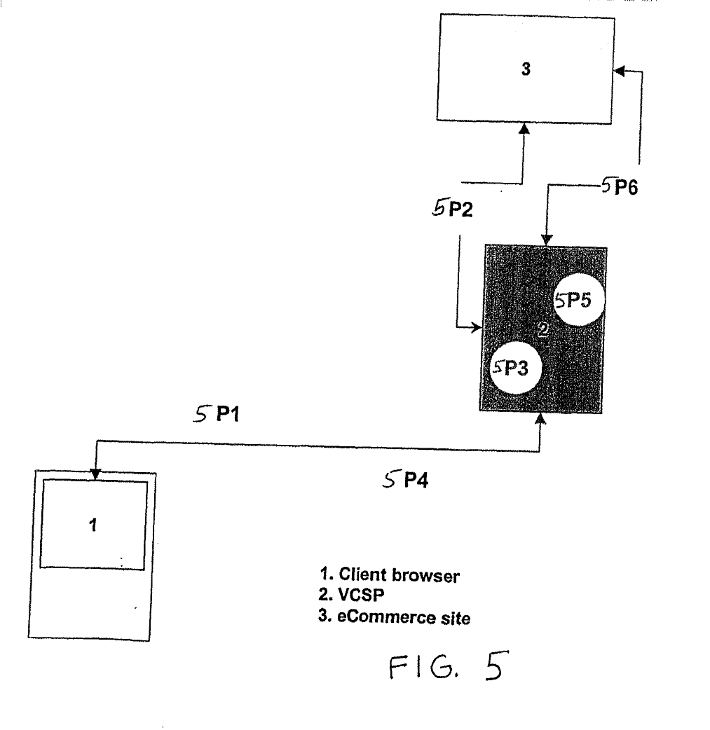

After setting the client modes or going with the defaults, the user proceeds to browse the Internet (or whatever form the communications link 140 takes). At some point, in order to pay for a product or service, the user needs to use a credit or bank card on a given website 110. The user then operates the service client 2 to obtain an e-currency ID to use in this payment The user (directly or through the client 2) supplies this generated e-currency ID to the website in lieu of the customary bank account and credit-card information. The site 110 accepts the generated e-currency ID and so notifies the user.

Where a user does not have access to his downloaded and personally configured client 2, the service 120 may provide a temporary client 2′ for his use. When a user is traveling, for example, he may log onto the service provider 120 using a regular browser, provide a user name and password and obtain a temporary client 2′. The user logs out and leaves the service 120 to handle the details of maintenance and clean up.

Where the service 120 offers it, the user may access the service through a web-based client (Refer FIG. 5)

### Viewpoint of Client

From the client 2′s viewpoint, the e-commerce transaction system 100 operates as follows: At the direction of the user, directly or through the browser 130, the client 2 communicates with the service provider 120 (more specifically, the e-currency-ID generator 128) and requests an e-currency ID. On receiving the e-currency ID the client 2 so notifies the user or the browser 130, as appropriate. (The client 2 and the service provider 120 may communicate to authenticate the client 2 itself.).

The provider 120 may reject the client 2's request for an e-currency ID for a number of reasons, including the following:

The provider 120 cannot authenticate the client 2.

Funds sufficient for the payment cannot be obtained from the account identified at registration.

The client 2 may so inform the user or browser 130 (as appropriate) of the rejection.

Alternatively, the service 120 may not be available at the time of the request The client 2 may so inform the user or browser 130 as appropriate.

The client 2 may communicate with the service provider 120 to obtain state information that the provider 120 maintains. The user-configurable settings are a particular example. This may be done automatically (on the client 2's invocation, for example), periodically (at predetermined time intervals) or on demand (when the user requests certain information). Each time the settings change, the client 2 may communicate with the service provider 120 in order to update the provider 120's database of modes for the user. Alternatively, the client 2 may communicate the change of settings only when the client 2 would otherwise have communicated with the service provider 120 for some other reason, e.g., requesting a new e-currency ID.

With the service 120 in card-reader mode, a client 2 attempts to read a card from an attached card reader 534. The information read from the card is transmitted to the server. Where the server validates the card information, the client 2 receives an e-currency ID in response.

The card may contain the registered user's user name and associated password. The card information is preferably encrypted.

A temporary client 2′ may automatically disable or delete itself it remains inactive for a predetermined period of time.

### Viewpoint of Service Provider

From the service provider 120's viewpoint, the e-commerce transaction system 100 operates as follows: On receiving a request for registration, the registrar 127 may request identifying information from the requestor or may obtain some of the identifying information from the protocols it uses to communicate with the requestor. This identifying information may include a user name and an associated password.

On receiving the identifying information, the registrar 127 may prepare a client 2 for downloading to the requester. In preparing a client 2, the registrar 127 may generate a client identifier (client ID), associate that client ID with the requested user name and password and embed that client ID in the client 2.

The registrar 127 also requests identifying and access information for at least one payment account (for example, a credit-card account number, expiration date, name of cardholder, billing address, etc.).

The provider registrar 127 downloads a client 2 to the requestor.

At some later time, the provider 120 receives a request from a client 2 (or an imposter) for an e-currency ID to complete an e-commerce transaction. The provider 120 may authenticate the client 2, (requesting and) receiving the user name, associated password and client ID previously associated with the requesting client 2. At this point, the provider 120 detects client impostors and rejects their requests.

On acceptance of the request for an e-currency ID the generator 128 generates an e-currency ID for use by the client 2 and returns that generated e-currency ID to the requester. Typically, the provider 120 encrypts the generated e-currency ID for transmission.

The generated e-currency ID may be transparent or opaque (from the viewpoint of the e-commerce site 110). When generating a transparent e-currency ID the generator 128 intends that an e-commerce site 110 not distinguish between the transparent e-currency ID and a credit-card account Transparent e-currency IDs have the form of a credit-card account That is to say, the generated transparent e-currency ID may have a 16-digit number similar to a credit-card account number, along with a four-digit number similar to a corresponding expiration date for that account.

When generating an opaque e-currency ID the generator 128 intends that an e-commerce site 110 recognize it as an e-currency ID and handle it as such.

The generator 128 may also associate an expiration time with the generated e-currency ID. An expiration time may be, for example, thirty (30) minutes after the time of the e-currency ID's generation.

The generated e-currency ID may incorporate user information, in a direct, distilled or encoded form. In any event, each generated e-currency ID is unique among the e-currency IDs that the generator 128 creates.

In card-reader mode, the provider 120 may automatically receive user information (such as user name and associated password) from the client 2 (that the client has read from the card by means of the card reader 534). The service 120 still performs its imposter-detection, request-acceptance and ID-generation steps.

Where the user has set the recurring-payment mode, the service 120 receives from the user merchant-identifier, merchant-account, payment-frequency and payment-amount information, for example. As mentioned above, the service 120 maintains this information.

The service 120 provides the user with an e-currency ID to supply to the specified merchant for recurring payments. A payment request using that e-currency ID from a merchant acts as a trigger for the service 120 to make a recurring payment. The service 120 may first verify the conditions of the request, for example, that the requesting merchant, the destination merchant account, the time since the last recurring payment, the validity period of the recurring payments, etc., are as the user specified when setting up the recurring payment The service 120 may also verify that the user has not changed the recurring-payment conditions, for example, by disabling recurring payments for this merchant or reducing the time period in which recurring payments may be made to this merchant.

(Only the single merchant may repeatedly use the recurring-payment e-currency ID and only for recurring payments, not for any other transactions. This is so because the e-currency ID technically expired on its first use.)

At some time later still, the provider 120 receives a request from a (presumed) e-commerce site 110 to verify for payment an e-currency ID that a user provided. Where the service is in notification mode for this user, the service 120 accordingly notifies the user. Where the confirmation mode is ON, the provider 120 communicates with the user to confirm that the user is actually performing the transaction.

The provider authenticator 129 confirms (or rejects) the validity of the e-currency ID. More particularly, the authenticator 129 may check the e-currency ID against its database of generated e-currency IDs. If the service 120 never generated the proffered e-currency ID it does not approve transactions based on the foreign ID.

It may check that the e-currency ID has not expired. After an e-currency ID expires, the authenticator 129 does not approve transactions based on the expired e-currency ID.

It may check that the e-commerce site 110 requesting authentication of the e-currency ID is the same site 110 for which the user requested an currency ID. If the former and latter sites 110 are not the same, the authenticator 129 does not approve transactions based on the expired e-currency ID.

The authenticator 129 checks whether a user has sufficient funds (in the account identified at registration) for payment for the instant transaction. On verification that the registered account can provide payment and, when necessary, that the user does want payment to be made, the server 120 creates, transmits and receives the information necessary to complete the payment. This information may be encrypted, e.g., using Secure Socket Layers (SSL).

The steps of confirming with the user, checking for sufficient funds and completing the transaction (from the service 120's viewpoint) are atomic. All the steps complete or the service 120 does not commit to the completion of the transaction.

On completing the transaction, the service 120 marks the e-currency ID as invalid. No one may re-use the e-currency ID for a subsequent purchase.

At some time after downloading a client 2, the service provider 120 may receive a request to update the modes for a registered user. Again, the service 120 may authenticate the requestor. On acceptance of the authenticity of the requestor, the service 120 and requestor communicate to update the provider 120's database of user modes.

The provider 120 maintains user settings. Thus, even if someone tampers with the client 2 (for example, attempts to override the card-reader mode by cracking the client 2), the service's security remains intact.

At some point after registration, the service provider 120 may receive a request from the user to log on remotely to the service, that is to say, to log on to the service using some software other than the previously downloaded client 2. The service 120 may accordingly provide a login screen, requesting the username and password established at registration. On successful login, the service may download a temporary client 2′ (an applet or other software) to the remote software. The temporary client 2′ may include code for automatic disablement or self-deletion if it remains inactive beyond a predetermined period of time (say, fifteen minutes).

Indeed, to increase the user's access to the service, the service 120 may offer a web-based client (Refer FIGS. 5,6) instead of a browser-based client 2. In this scenario, the user logs on to the service provider 120, using a user name and password, and accesses the e-commerce site through the service provider 120.

Qua a web-based client, the server 120 retrieves and parses content from an e-commerce site 110 that the user identifies. The server 120 adds scripts or applets to the content so that it can automatically add the e-currency ID. Alternatively, the server 120 may modify the Uniform Resource Locator (URL) so that any submitted form is sent to the service provider 120.

This way, the user views the document exactly as it would have been if viewed directly from the e-commerce site 110 except that the added code automatically handles any card information. When the user submits the form (without having filled in any card information), the added code automatically inserts the e-currency IDs, or the modified URL causes the service provider 120 to automatically insert the c-currency IDs. The provider 120 then sends the filled-in form to the e-commerce site 110.

The service 120 may facilitate users' providing feedback or ratings of e-commerce sites 110. This facility provides users with information on how an e-commerce site 110 performs on customer-satisfaction metrics such as scheduled delivery and quality of products.

### Viewpoint of E-Commerce Site

From the e-commerce site 110's viewpoint, the e-commerce transaction system 100 operates as follows: A user accesses the e-commerce site 110 using a browser 130. The site 110 offers services or goods for purchase, and the user makes a selection of these products. At some point, the user proceeds to a check out screen to pay for the selection.

The site 110's payment screen includes areas for inputting a credit- or bank-card account number and an expiration date or PIN. The user provides an e-currency ID instead.

Where the e-currency ID is transparent, the site 110 interprets the e-currency ID as credit-card account information. The site 110 proceeds to request that its account-services provider (the payment gateway) validate that the user-identified account has sufficient funds to pay for the selected goods and services. The account-services provider recognizes the user-identified account as an e-currency ID of the service 120 and in turn asks the service 120 to verify that the user-provided e-currency ID is good to complete the transaction.

(The account-services provider and the service provider 120 may be one and the same. That is to say, the service provider 120 operates the payment gateway (for a card provider such as Visa® or MasterCard®).).

Where the e-currency ID is opaque, the e-commerce site 110 identifies the e-currency ID as such and contacts the provider 120 to complete the transaction.

In the foregoing, the site 110 receiving the e-currency ID does not receive the account information transmitted during a prior-art transaction. e-Wallet, for example, transmits credit or bank-card information during a transaction. Indeed, an e-Wallet and other virtual wallets can be improved by including an e-currency ID.

Further, virtual wallets require an e-commerce site 110 to make specific changes to accommodate them. Where a leading card provider implements the invention, an e-commerce site 110 does not need to change in order to accommodate e-currency IDS.

A generated e-currency ID is unique for each session of the browser and cannot be reused. This way, if a potential malfeasant compromises the site 110's security, the generated e-currency IDs cannot be used to make additional purchases.

By using e-currency IDs instead of prior-art user or account information and by storing the actual credit-card or account information only at the service provider's server, the invention centralizes security issues at the service-provider level instead of distributing them across the e-commerce sites 110. Many small business e-commerce sites do not have the necessary security infrastructure and are easy targets for crackers to steal credit- and bank-card information. The server 120 typically includes firewall and other security mechanisms to effect much more secure and private transactions.

Another advantage of e-currency IDs is user control and feedback. With the service client 2, the user can know exactly who is accessing his account, how much is being charged and when. The user can also decline a transaction any time before confirmation. Further, the user can disable recurring payments by modifying the user configuration.

Another advantage is convenience. The client 2 can be configured to automatically provide often-used information such as a billing address. Also, payment information can be automatically recorded into personal-finance tools such as Quicken, MS Money, etc.

Small- and medium-sized e-commerce sites sometimes have to outsource merchant services, charging a credit card or transferring the amount to the e-commerce company, as examples. The service 120 provides a secure and economic alternative, as the service 120 can make payments directly into the e-commerce company's account.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

I claim:

1. A method for making payments on the Internet, comprising:
a user obtaining a unique ID from a Service Provider when said user wants to make a payment on the Internet;
said user communicating said ID to a vendor in place of a credit card; and
said vendor completing or rejecting the transaction by communicating with said Service Provider.

2. The method of claim 1, the method further comprising said user registering with said Service Provider and obtaining a Client from said service Provider all prior to the step of a user obtaining a unique ID.

3. The method of claim 1, wherein before the step of completing the transaction, said method further comprising:
said Service Provider validating said unique ID and account balances of said user and completing said payment only if said unique ID is valid and has not expired and said user balances are adequate; and
said Service Provider sending acceptance to the vendor.

4. The method of claim 1, wherein before the step of rejecting the transaction, the method further comprising said Service Provider validating said unique ID and account balances of said user and sending a rejection to said vendor if said user balances are inadequate or said unique ID is invalid or has expired.

5. The method of claim 1, wherein said ID has a preset timeout, wherein after said preset timeout expires, said ID will not be approved by said Service Provider, and once used, said ID will not be approved again by said Service Provider.

6. The method of claim 2, wherein said Service Provider Client has at least one mode of operation selected from the group consisting of a notification mode, a confirmation mode, a card reader mode and a recurring payment mode.

7. The method of claim 6, further comprising operating said Client in said notification mode, wherein anytime a vendor requests validation of an ID, said Service Provider notifies said user.

8. The method of claim 6, further comprising operating said Service Provider client in said confirmation mode, wherein anytime said vendor requests validation of a ID generated by said user, a confirmation is requested from said user, wherein only after said user authorizes the transaction does said Service Provider provide approval for said transaction.

9. The method of claim 6, further comprising operating said Client in said card reader mode, wherein said Client works only after said user inserts a service card into a special reader attached to a PC.

10. The method of claim 6, further comprising operating said VCSP client in said recurring payment mode, wherein recurring payment information needed to complete a recurring transaction is stored at said Service Provider, wherein a request from said vendor that provides a previously used ID acts as a trigger for said recurring transaction.

11. The method of claim 2, wherein said Client has the capability to record payment details into desktop or web-based personal finance tools.

12. The method of claim 2, wherein said Client is a separate application interacting with a browser.

13. The method of claim 2, wherein said Client comprises code running on a browser.

14. The method of claim 2, wherein said Client is entirely web based.

15. The method of claim 1, wherein said Service Provider includes a server that stores user settings.

16. A method for completing a secure e-commerce transaction between a customer and a vendor, both connected to a network, while protecting information even if vendor's security is breached and providing end-to-end user control, comprising:
obtaining a single use ID from a Service Provider (SP) when a customer is ready to place an order;
transmitting said ID to a vendor in place of credit card information or bank account information of said customer;
sending information from said SP to said customer system when said vendor requests payment and taking user confirmation; and
sending acceptance/rejection to said vendor from said SP after validating customer balances.
